(19) United States
(12) Patent Application Publication
(10) Pub. No.: US 2003/0182385 A1
(43) Pub. Date: Sep. 25, 2003

(54) Portable terminal equipment, notifying method and its program

(75) Inventor: Yuzuru Suzuki, Kanagawa (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/388,534

(22) Filed: Mar. 17, 2003

(30) Foreign Application Priority Data
Mar. 20, 2002 (JP) 77441/2002

(51) Int. Cl. G06F 15/16

(52) U.S. Cl. 709/206

(57) ABSTRACT

Portable terminal equipment according to the invention is provided with registering means for registering a predetermined character string and specific notifying operation corresponding to the character string. When the terminal receives an electronic mail, it retrieves the registered character string. In case the received electronic mail includes the character string, the registered notifying operation is executed when the electronic mail is received, when it is displayed or both. If a user of the portable terminal equipment arranges the input of a specific character string to an electronic mail with a specific partner, an electronic mail from the partner can be easily discriminated when an electronic mail is received or displayed.

### BACKGROUND OF THE INVENTION

1. Field of the Invention

The present invention relates to portable terminal equipment, a notifying method and its program, particularly relates to portable terminal equipment that notifies the reception of a specific electronic mail, a method of notifying it and a program.

2. Description of the Related Prior Art

Recently, an electronic mail has been widely transmitted or received by a mobile telephone. A user of a mobile telephone can set an inherent method of notifying the reception of an electronic mail. For the notice of incoming, the ringing of a sound and a melody for telling incoming, the flickering and the lighting of a liquid crystal display or another light emitting device can be given. However, notifying operation in receiving is fixed in any electronic mail. The user can know the contents of the following electronic mail first when the user makes a received electronic mail display and reads the electronic mail. A user cannot know that an electronic mail is a special electronic mail from notifying operation when the electronic mail is received or displayed.

### SUMMARY OF THE INVENTION

Therefore, the object of the invention is to provide portable terminal equipment that can execute notifying operation reflecting the contents of a received electronic mail, its notifying method and its program.

To achieve the object, portable terminal equipment according to the invention is provided with registering means for registering a character and notifying operation corresponding to the character, retrieving means for retrieving the character from a received electronic mail, a memory that stores notifying operation and a control unit that controls the notifying operation, and in case an electronic mail includes a registered character, corresponding notifying operation is executed. In the portable terminal equipment, the character may be also a character string, the control unit can be provided with a display controller and a ringing controller and in the registering means, plural types of character strings, notifying operation corresponding to each character string and the priority of each character string can be registered. Further, concretely, plural character strings can be registered in the same order of priority, notifying operation can be executed at least either when an electronic mail is received or when it is displayed and is at least one of the flickering of a display, the lighting of the display, the ringing of a sound and vibration. This portable terminal equipment can be registered so that notifying operation is not executed in case an electronic mail includes no registered character.

A method of operating a mobile telephone terminal according to the invention is provided with a step for retrieving a predetermined character string from a received electronic mail and a step for executing predetermined notifying operation in case the electronic mail includes the character string. This operating method can be further provided with a step for registering a character string and notifying operation corresponding to the character string in the portable terminal equipment beforehand. Further, in the operating method, in case an electronic mail includes plural types of character strings, notifying operation corresponding to the character string having the highest order of priority can be executed and an electronic mail including a character string having the highest order of priority of undisplayed plural electronic mails can be first displayed.

The invention can provide a program for executing character retrieving operation and notifying operation in the portable terminal equipment by controlling a computer. The program is provided with a step for retrieving a predetermined character string from a received electronic mail and a step for executing notifying operation corresponding to the character string in case the electronic mail includes the character string. The notifying operation can be executed according to registration at least either when an electronic mail is received or when it is displayed.

According to the invention, a user of the portable terminal equipment can know an electronic mail including a character string registered before hand when the electronic mail is received or displayed.

### BRIEF DESCRIPTION OF THE DRAWINGS

The above and other objects, features and advantages of the present invention will become apparent from the following detailed description when taken with the accompanying drawings in which:

FIG. 1 shows an example of a communication system;

FIG. 2 is a block diagram showing an embodiment of portable terminal equipment according to the invention;

FIG. 3 is a flowchart showing an embodiment of method of registering a character string and notifying operation;

FIG. 4 is a flowchart showing an embodiment of the notifying operation of the portable terminal equipment; and

FIG. 5 is a flowchart showing another embodiment of the notifying operation of the portable terminal equipment.

### DETAILED DESCRIPTION OF THE PREFERRED EMBODIMENTS

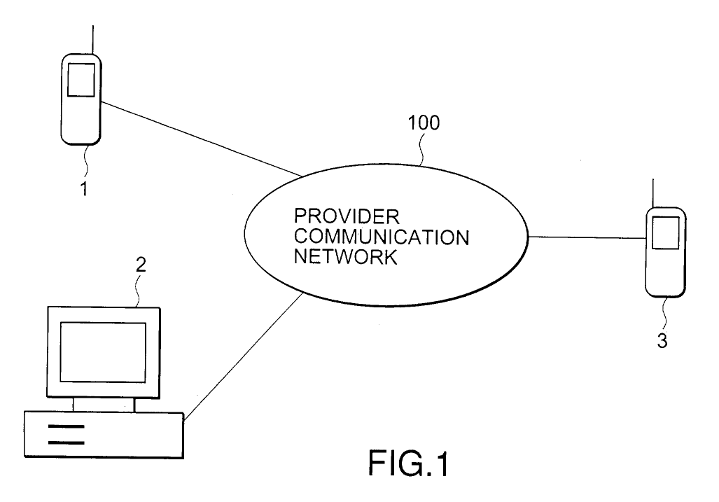

As shown in FIG. 1, portable terminal equipment 3 is connected to another portable terminal equipment 1 and a computer 2 via a network 100 of a network service provider. For example, suppose that a user A of the portable terminal equipment 3 wants to read an electronic mail from a user B of the portable terminal equipment 1 first of all out of received electronic mails. At that time, the user A asks the user B to make a specific character string included in the electronic mail addressed to the user A. Further, the user A registers the specific character string and specific notifying operation corresponding to the character string with the portable terminal equipment 3. In case the portable terminal equipment 3 receives an electronic mail from the user B, it detects the registered specific character string in the received electronic mail and executes the corresponding specific notifying operation. As a result, the user A knows that the received or displayed electronic mail is an electronic mail from the user B. The user A can also make the electronic mail from the user B displayed in advance of the other received electronic mails. The user B can also execute the same operation as the user A. Even if no agreement is made with a specific partner, a user of portable terminal equipment can register a specific character string and specific notifying operation corresponding to it and can discriminate an electronic mail including the character string from another mail.

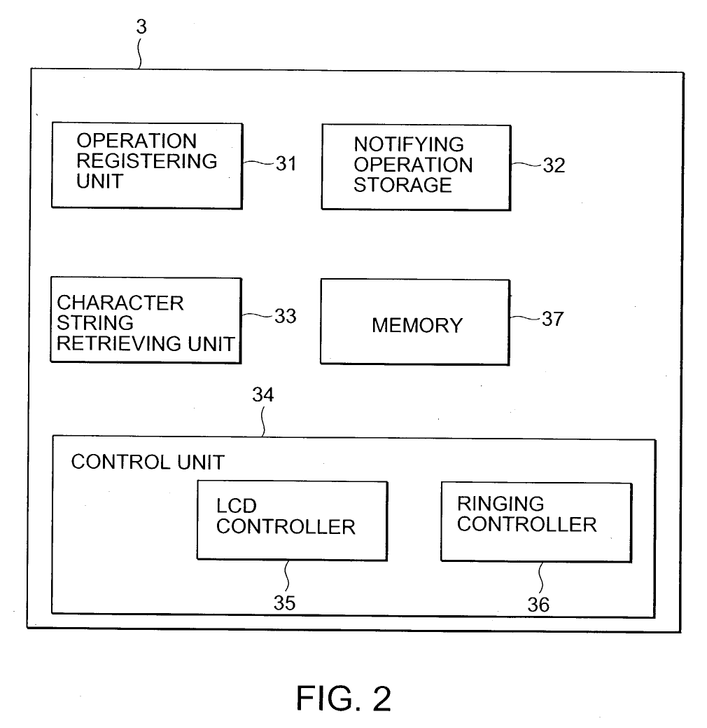

As shown in FIG. 2, portable terminal equipment 3 equivalent to an embodiment includes an operation registering unit 31, a notifying operation storage 32, a character string retrieving unit 33, a control unit 34 and a memory 37. The control unit 34 is provided with an LCD controller 35 and a ringing controller 36. The portable terminal equipment 3 can be also provided with a radio transmitter-receiver, a speaker, an earphone, a display (LCD), a keyboard, a vibrator and other normal equipment (not shown) for example. A user registers a predetermined character string and notifying operation corresponding to the character string such as one or more of the lighting/flickering of the display, ringing and vibration and whether these are operated in either of receiving or display or in both in the operation registering unit 31. Portable terminal equipment is normally provided with a memory in which plural types of notifying operation is stored beforehand. The notifying operation storage 32 can be provided with a function of the memory. A user can select specific notifying operation out of operations stored beforehand. The notifying operation storage 32 stores a character string input from the operation registering unit 31 and notifying operation corresponding to the character string. The notifying operation storage 32 can store the input character string and correspondence between the character string and the selected notifying operation. The character string retrieving unit 33 retrieves a character string stored in the notifying operation storage 32 from a received electronic mail. The control unit 34 controls the execution of the corresponding notifying operation when the character string retrieving unit 33 detects the character string and controls the whole portable terminal equipment. The LCD controller 35 controls the lighting/flickering of the display (LCD) and back LCD according to an instruction from the control unit 34 or controls the lighting/flickering of the illumination of these LCDs. The ringing controller 36 controls ringing from the speaker (not shown), the vibration of the vibrator or both according to an instruction from the control unit 34. The memory 37 stores a program for controlling the above-described operations.

The notifying operation storage 32, the character string retrieving unit 33 and the control unit 34 can be formed in the same CPU. Further, the CPU can include the memory 37. A user can input plural character strings-and notifying operation corresponding to each character string into the operation registering unit 31 and can register priority (including the same order) for each character string. One notifying operation can be registered for the combination of plural types of character strings. A user can input one character in place of a character string. An alphabet of each language, kanji, a symbol and others can be utilized for a character string or a character. A user can prevent notifying operation from being executed for an electronic mail not including an input character string or an input character by registering it in the operation registering unit 31 or can register specific notifying operation.

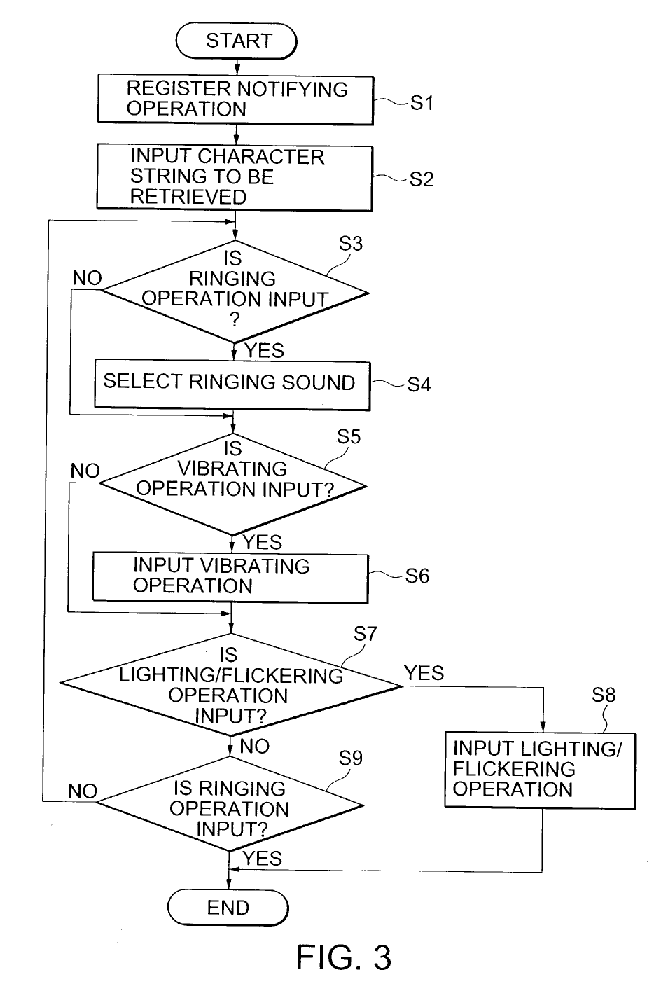

FIG. 3 is a flowchart showing an embodiment for registering notifying operation with a mobile telephone terminal 3. A user turns the mobile telephone terminal 3 into a mode for inputting notifying operation (S1). Next, the user inputs a character string to the operation registering unit 31 (S2). Next, the user inputs notifying operation corresponding to the input character string. It is judged whether ringing operation is registered or not (S3). In case ringing operation is registered, one of plural ringing operations stored in the memory of the portable terminal equipment 3 is selected (S4). Next, it is judged whether vibrating operation is registered or not (S5). When the registration of vibrating operation is determined, vibrating operation is input (S6). Next, the lighting/flickering operation of the display is judged (S7). When the registration of the operation of the display is determined, specific operation is selected out of display operations stored in the memory (S8). When it is judged that the operation of the display is not registered, it is judged whether ringing operation is registered or not (S9). If ringing operation is registered, the registration of notifying operation is finished. In case ringing operation is not registered, the registration of ringing operation is judged again (S3). The user can register by inputting to the operation registering unit 31 so that the notifying operation is executed when an electronic mail is received, when the electronic mail is displayed or both. Different operations can be registered when an electronic mail is received and when the electronic mail is displayed.

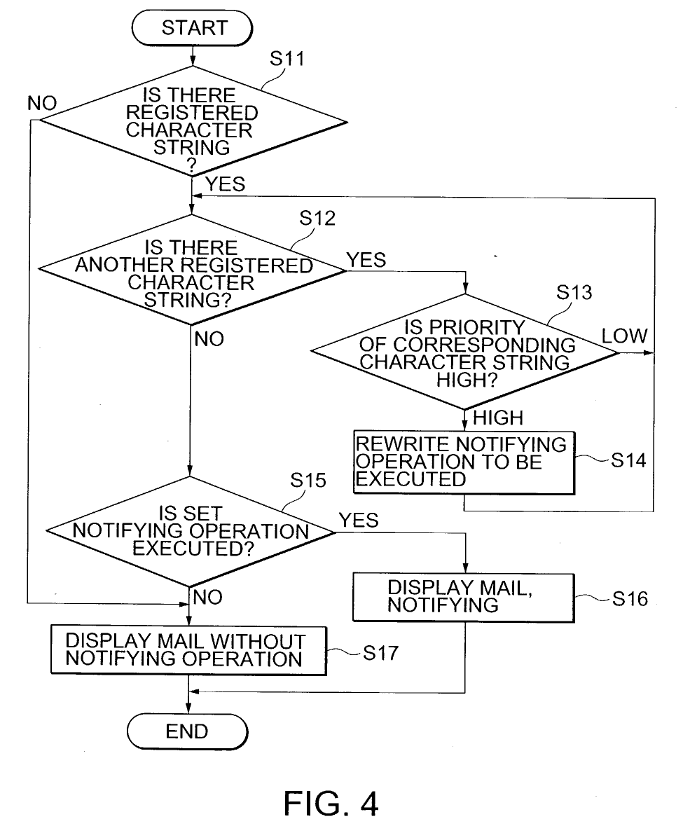

FIG. 4 shows an embodiment of the notifying operation of the portable terminal equipment 3. In this embodiment, a case that notifying operation is executed at the same time as a received electronic mail is displayed is shown. When the portable terminal equipment 3 receives an electronic mail, the character string retrieving unit 33 determines whether the electronic mail includes a character string registered beforehand or not (S11). When no registered character string is detected (NO of S11), the electronic mail is displayed without notifying operation (S17). When the registered character string is detected (YES of S11), the character string retrieving unit 33 determines whether the electronic mail includes another registered character string or not (S12). In case another registered character string is detected (YES of S12), priority between the detected character strings is judged (S13). In case the order of priority of the character string detected later is lower (LOW of S13), another registered character string is retrieved again (S12). In case the order of priority of the character string detected later is higher (HIGH of S13), notifying operation written before is rewritten to notifying operation registered corresponding to the character string (S14). In case another registered character string is not detected in the electronic mail (NO of S12), it is judged whether notifying operation is executed when the electronic mail is displayed or not (S15). Afterward, at the same time as the electronic mail is displayed, the notifying operation is executed (S16). Or the electronic mail is displayed without notifying operation (S17).

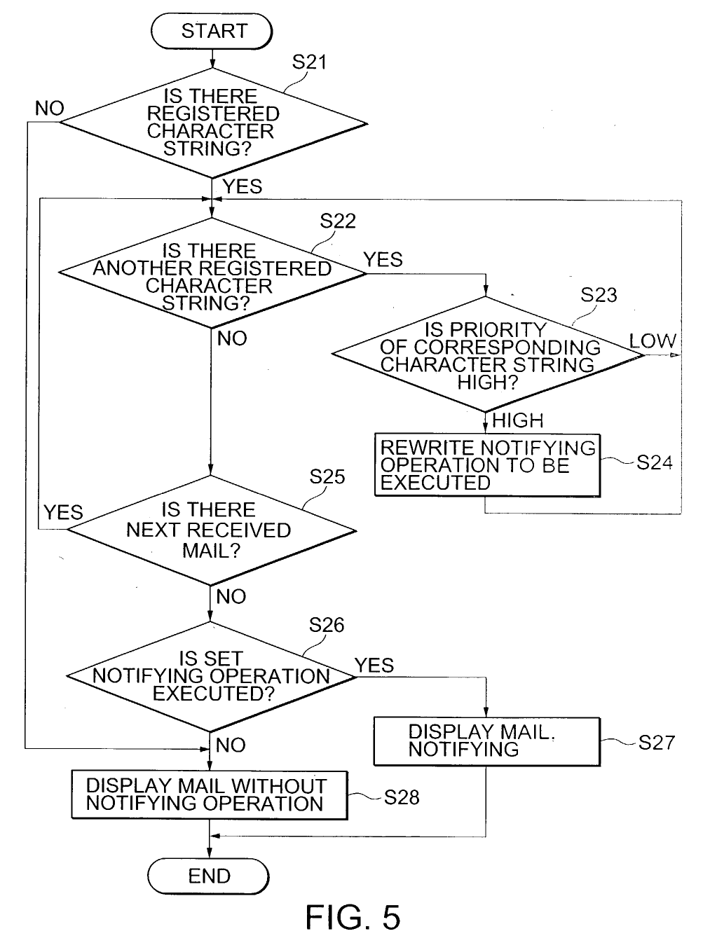

FIG. 5 shows another embodiment of the notifying operation of the portable terminal equipment 3. In this embodiment, as in the above embodiment, a case that notifying operation is executed at the same time as a received electronic mail is displayed is also shown. Operations in S21 to S24 are the same as the above operations. In case the character retrieving unit 33 does not detect another registered character string in an electronic mail (NO of S22), the portable terminal equipment 3 judges whether another electronic mail is received or not (S25). In case another electronic mail is received (YES of S25), the operations in S22 to S24 are repeated again. In case another electronic mail is not received (NO of S25), it is judged whether registered notifying operation is executed when the electronic mail is displayed or not (S26). Afterward, at the same time as the electronic mail is displayed, the notifying operation is executed (S27). Or the electronic mail is displayed without notifying operation (S28).

The portable terminal equipment 3 can display an electronic mail including a character string having higher order of priority in advance in case the portable terminal equipment receives plural electronic mails including a registered character string. In case plural electronic mails respectively include a character string having the same priority, the portable terminal equipment can display them in received order for example. The portable terminal equipment 3 can execute notifying operation when it receives an electronic mail. Further, the portable terminal equipment 3 can execute the same notifying operation or different notifying operations both when the portable terminal equipment receives an electronic mail and when it displays the electronic mail.

The portable terminal equipment according to the invention can receive or display an electronic mail including a specific character or a specific character string apart from electronic mails except the electronic mail.

While the present invention has been described in connection with certain preferred embodiments, it is to be understood that the subject matter encompassed by the present invention is not limited to those specific embodiments. On the contrary, it is intended to include all alternatives, modifications, and equivalents as can be included within the spirit and scope of the following claims.

What is claimed is:

1. Portable terminal equipment that transmits and receives an electronic mail, comprising:
registering means for registering a character and notifying operation corresponding to the character;
retrieving means for retrieving the character from a received electronic mail;
a memory that stores notifying operation; and
a control unit that controls notifying operation, wherein:
in case the received electronic mail includes the registered character, the corresponding notifying operation is executed.

2. Portable terminal equipment according to claim 1, wherein:
the character is a character string.

3. Portable terminal equipment according to claim 1, wherein:
the control unit is provided with a display controller and a ringing controller.

4. Portable terminal equipment according to claim 1, comprising:
a memory for storing a program for operating the portable terminal equipment.

5. Portable terminal-equipment according to claim 2, wherein:
plural types of character strings, notifying operation corresponding to each character string and the priority of each character string can be registered in the registering means.

6. Portable terminal equipment according to claim 5, wherein:
plural character strings can be registered in the same order of priority.

7. Portable terminal equipment according to claim 1, wherein:
the notifying operation is executed when an electronic mail is displayed.

8. Portable terminal equipment according to claim 1, wherein:
the notifying operation is executed when an electronic mail is received.

9. Portable terminal equipment according to claim 1, wherein:
the notifying operation is executed when an electronic mail is received and is displayed.

10. Portable terminal equipment according to claim 1, wherein:
the notifying operation is at least one of the flickering of a display, the lighting of the display, the ringing of a sound and vibration.

11. Portable terminal equipment according to claim 1, wherein:
in case the electronic mail includes no registered character, no notifying operation is executed.

12. A method of operating a mobile telephone terminal that transmits and receives an electronic mail, comprising:
a step for retrieving a predetermined character string from a received electronic mail; and
a step for executing predetermined notifying operation in case the electronic mail includes the character string.

13. A method of operating according to claim 12, comprising:
a step for registering a character string and notifying operation corresponding to the character string in portable terminal equipment beforehand.

14. A method of operating according to claim 12, wherein:
the notifying operation is executed at least either when an electronic mail is received or when the electronic mail is displayed.

15. A method of operating according to claim 12, wherein:
the notifying operation is at least one of the flickering of a display, the lighting of the display, the ringing of a sound and vibration.

16. A method of operating according to claim 13, wherein:
plural types of character strings and priority among these can be input.

17. A method of operating according to claim 16, wherein:
in case an electronic mail includes plural types of character strings, notifying operation corresponding to the character string having the highest order of priority is executed.

18. A method of operating according to claim 16, wherein:
in case undisplayed plural electronic mails are received, the electronic mail including a character string having the highest order of priority is first displayed.

19. A method of operating according to claim 12, wherein:
in case an electronic mail includes no registered character string, no notifying operation is executed.

20. A program for executing character retrieving operation and notifying operation in portable terminal equipment by controlling a computer, comprising:
a step for retrieving a predetermined character string from a received electronic mail; and
a step for executing notifying operation registered corresponding to the character string in case the electronic mail includes the character string.

21. A program according to claim 20, wherein:
the notifying operation is executed according to registration at least either when an electronic mail is received or when the electronic mail is displayed.
